(19) United States
(12) Patent Application Publication
(10) Pub. No.: US 2020/0256488 A1
(43) Pub. Date: Aug. 13, 2020

(54) Pipe Joint Restraint

(71) Applicant: Dennis Roach, Ooltewah, TN (US)

(72) Inventor: Dennis Roach, Ooltewah, TN (US)

(21) Appl. No.: 16/274,705

(22) Filed: Feb. 13, 2019

(51) Int. Cl. F16L 21/08; F16L 21/03; F16L 21/00

(52) U.S. Cl. CPC F16L 21/08; F16L 2201/20; F16L 21/007; F16L 21/03

(57) ABSTRACT

A pipe restraint utilizes a wire grip about an exterior surface of a pipe section to be joined to another structure. The grip applies a gripping force to the pipe section to retain it from outward movement relative to the structure. Some embodiments utilize an internal surface of the structure to assist in applying a force through the grip to the exterior surface. Some embodiments utilize a separate gland to assist in applying force through the grip to the exterior surface. Still other embodiments direct forces through a flange on the structure to pull wires about the exterior surface of the pipe section.

### FIELD OF THE INVENTION

The present invention relates generally to pipe joint restraints for coupling the ends of pipe to one another or coupling the end of a pipe to another structure such as a valve or other members that are often coupled to pipes.

### BACKGROUND OF THE INVENTION

Pipes, such as water pipes, are often coupled to one another, often to transmit a fluid under pressure. Water pipes, and other pipes, are also often coupled to structures including valves, fittings, joints, and other structures. In the prior art, some water pipes are flanged at the end. The flanges often have cooperating bores so as to be able to bolt adjacent pipe sections together. However, there are many situations in which flange connections are not desirable, feasible, or otherwise available.

In at least some situations, a coupling device often referred to as a mechanical joint can be used when one of the pipes does not have an available flanged end. In that situation, the end of the non-flanged pipe can be received into a flared end of a flanged member (such as a pipe) possibly with a following ring or annual gland situated over the pipe adjacent to the flange. A gasket is often provided which can compress into the pipe surface and against the flare of the other member to create a water-right seal as the following ring is bolted to the flange.

While mechanical joints are suitable for maintaining a water-tight connection, in many situations they fail to be able to withstand the hydraulic thrust forces which might tend to cause the pipes with internal pressurized fluid to spread apart in the direction they are joined. In order to reduce the risk that the pipes may come apart (particularly since they are often located underground once installed and covered over) pipe joint restraints are often provided with, as a part of, or instead of mechanical joints. One such pipe joint restraint is shown and described in U.S. Pat. No. 7,484,775, which is incorporated herein in its entirety by reference. The '775 patent attempts to overcome defects with the prior art by providing such a restraint in which the top heads of bolts sheer off under a predesigned torque load so as to keep from damaging the pipe to which it is attached. However, making these type restraints is not necessarily inexpensive. They certainly would normally cost significantly more than a typical angular gland commercially available in the marketplace. They also attach the restraining bland in three specific locations about the exterior surface of the attaching pipe section.

A mechanical joint as shown in FIG. 1 is known to provide a water-tight seal and provides a gland which may contact a gasket located internal to a flared end of a flanged member. Improvements over this as well as prior art pipe joint restraints are believed to be necessary or desirable under some circumstances.

### SUMMARY OF THE INVENTION

Accordingly, it is a present object of many embodiments of the present invention to provide an improved pipe restraint for use in joining a pipe section to another structure.

It is another object of many embodiments of the present invention to provide an improved pipe restraining system which restrains one pipe portion from becoming dislodged relative to other structure.

It is another object of many embodiments of the present invention to provide an improved pipe restraint which circumscribes an exterior surface portion of a pipe and assist in providing a frictional connection of that pipe portion at the exterior surface to another structure.

Another object of many embodiments of the present invention is to provide an improved pipe restraint which has a wire such as a braided, twisted wire or other structure which can be placed about an exterior surface of a first pipe portion and connect to a second structure so that the wire becomes deformed and/or tight about an exterior surface of the first pipe portion thereby effectively digging into the exterior surface to assist in restraining the first pipe portion relative to the other structure.

Some embodiments may utilize a gland in combination with a flanged end of a structure (such as a second pipe portion) with the gland potentially contacting a wire structure or grip such as a wire rope, twisted wire, braided wire and/or other wire ring like structure so as to at least assist in potentially deforming the wire grip against an exterior surface of a portion of pipe.

Another embodiment may rely on a similar wire structure grip against an exterior surface, possibly independent of a gland, and while possibly assisted in being pushed into position by a second pipe end structure or other structure; some embodiments may utilize a combination of both of these.

Still another embodiment may operate somewhat similar to U.S. Pat. No. 1,670,543, incorporated herein in its entirety by reference, in that a wrap of wires may be placed about the pipe. However, instead of applying a force to connect from a central co-actually disposed screw 7 or 5 as shown in that reference, the ends of the wires of the grips are preferably directed through bores in a flanged end of a member and preferably threaded therethrough so as to be able to apply tension from wires radially (and externally) about the pipe in a restraining manner to compress about an external surface. Basically, by pulling outwardly away rather than inwardly like the '543 Patent some of these embodiments may be placed about the pipe before installation and some others may envision an ability to put on after installation (such as by initially being split up a side but then connected) and then tightening as a subsequent step as described and shown herein.

Still further embodiments may utilize wire grips (or other grips) in various ways to assist in restraining one pipe portion relative to another as shown and described herein.

### BRIEF DESCRIPTION OF THE DRAWINGS

The accompanying drawings illustrate preferred embodiments of the invention and, together with the description, serve to explain the invention. These drawings are offered by way of illustration and not by way of limitation:

FIG. 1 is a cross sectional view of a prior art pipe restraint;

FIG. 2 is a cross sectional view of a presently preferred embodiment of the present invention;

FIG. 3 is a cross sectional view of a first alternative embodiment of the present invention;

FIG. 4 is a cross sectional view of a second alternative embodiment of the present invention;

FIG. 5 is an end plan view as could be viewed along the lines A-A, B-B or C-C in FIGS. 2-4;

FIG. 6 is a perspective view of a portion of the wire member shown in FIGS. 2-5;

FIG. 7 is a cross sectional view showing a third alternative embodiment of the present invention;

FIG. 8 shows a cross sectional view of the embodiment shown in FIG. 7 showing an effort to disengage the pipe portions together;

FIG. 9 shows a front plan view of a fourth alternative embodiment of the present invention;

FIG. 10 shows a rear plan view of a portion of the embodiment shown in FIG. 9.

### DETAILED DESCRIPTION OF THE PREFERRED EMBODIMENT

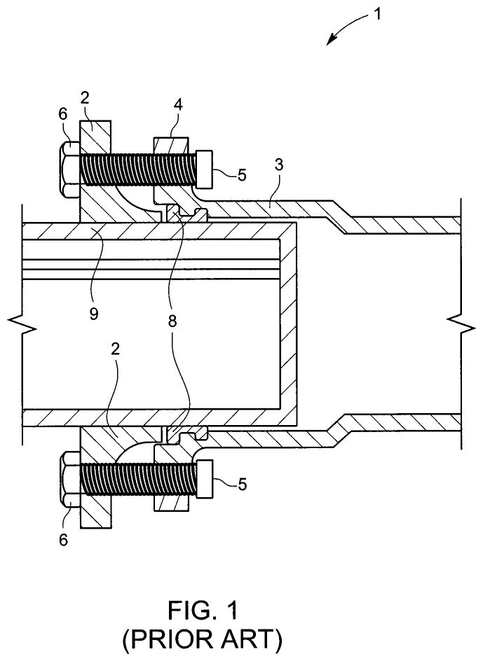

FIG. 1 shows a prior art mechanical joint 1 having an annular gland 2 connecting to a structure such as a second pipe end or portion 3 at flange 4 with a plurality of bolts 5 extending through nuts 6 so as to compress gasket 8 to provide a water-tight connection of a first pipe portion 9 with the second pipe portion 3. Mechanical joints have been in use for many, many years. However, as discussed above, mechanical joints typically provide for a water seal, but they do not provide significant restraining capabilities at this location for the pipe portions 3,9 to keep from separating. One can quickly see that with a 6 inch pipe subjected to 100 or more pounds per square inch (psi) of pressure, that when water under pressure is placed in the piping system, there would be a significant force tending to pull the pipe portion 3 away from the second pipe portion 9, such as if under 100 psi, about 2700 pounds of pull apart force. Greater water pressures would even tend to have a greater forces tending to pull the portions 3,9 apart.

Technology such as U.S. Pat. No. 7,484,775 have attempted to address this issue by providing a pipe joint restraint to connect one pipe portion to another while attempting to overcome disadvantages of other prior art pipe restraints. However, in order to make the pipe restraint construction of the '775 Patent device, significant expense would be required by that structure and it would connect to the first pipe portion at three distinct and spread apart locations.

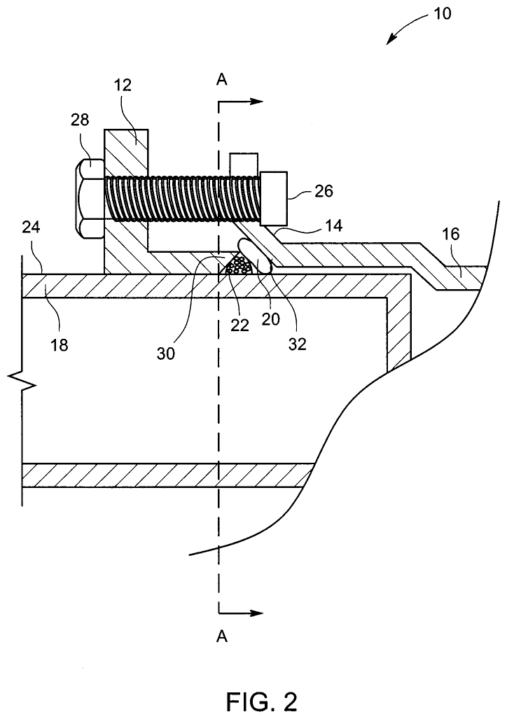

The applicant has developed a first embodiment of a pipe restraint 10 shown in FIG. 2. Specifically, a gland 12 can be retained to a flanged end 14 of a second pipe portion 16 which can be connected to a first pipe portion 18 as will be described in further detail herein.

While this structure compresses a gasket 20 to provide a water-tight seal as is done in the prior art, the gland 12 may also assist in deforming a wire structure or grip 22 such as a wire rope, a braided wire, a twisted wire or other structure which can potentially deform against an exterior surface portion 24 of the first pipe portion 18 so as to mechanically grab that exterior surface portion 24 preferably in a circumnavigational type manner (i.e., the wire structure or grip 22 can be a ring which can be at least substantially, if not completely, circumscribe the exterior surface 24 of the first pipe portion 18. The grip can connect at least two threads of a parameter of a circumference of the external surface portion 24 at the first pipe portion 18. The wire structure or grip 22 preferably retains the first pipe portion so that the first pipe portion 18 does not become dislodged relative to the second structure, illustrated as second pipe portion 16 when an internal pressure of a significant amount such as 100 psi or more is applied internal to the pipe portion 16,18. Second structure could not only be second pipe portions 16, but also valves, joints, and/or other structure to which the first pipe portion 18 connects.

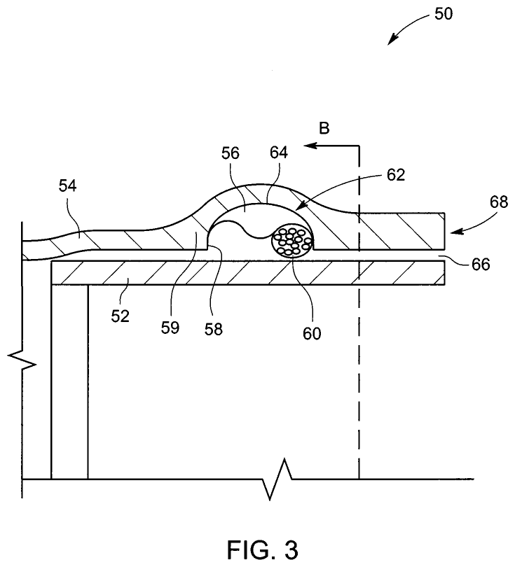

FIG. 3 shows a first alternative embodiment of the structure shown in FIG. 2 in the form of a pipe joint restraint 50 which could be a somewhat similar and yet somewhat different construction in the fact that a first pipe portion 52 is connected to a second pipe portion 54. In some embodiments, the pipe portions 52,54 may be made of polyvinyl chloride (PVC), galvanized iron, ductile iron, steel or other appropriate materials. In a PVC construction, an internal gasket 56 may be preconnected to the second pipe portion 54 such as by being adhered thereto or otherwise connected. There is often a groove 58 along interior surface 59 into which the seal or gasket 56 is placed. In such an embodiment, it may be possible to place the wire structure or grip 60 towards a leading edge and/or other leading portions 62 of the groove 58 so that should the first pipe portion 52 tend to pull away from the second pipe portion 54, the wire structure or grip 60 is compressed by the curved and/or angular surface 64 of the groove towards the leading edge 62 against the exterior surface 66 of the first pipe portion 52 to assist in performing a mechanical lock of the first pipe portion 52 with the second pipe portion 54. Grip 60 may contact the gasket 56 and/or be connected to it for some embodiments, if not formed into it, or possibly encapsulated by it in some embodiments. Angular surface 64 initially proceeds upwardly as it progresses away from pipe end 70 along groove 58 so that it downwardly directs grip 60 against the external surface 66 of first pipe portion 57. It may be possible to use retaining flanges and/or glands such as shown in FIG. 2 for some embodiments even with this construction or not.

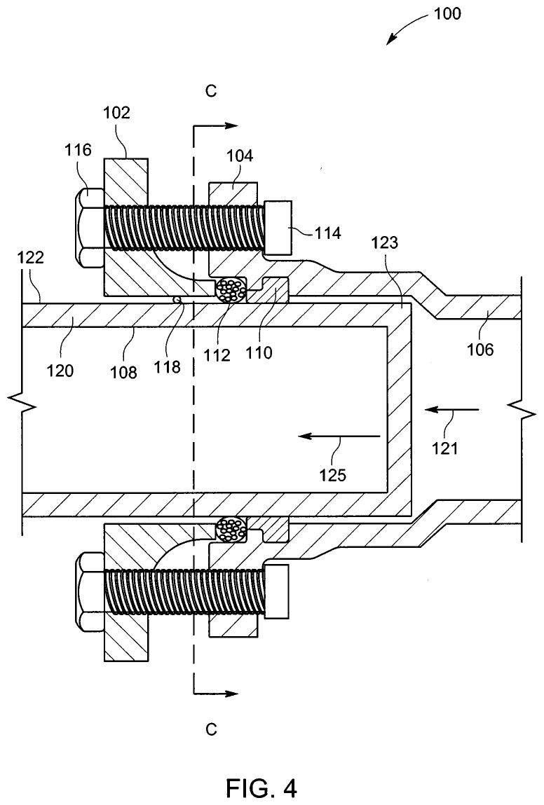

FIG. 4 shows yet another embodiment similar to FIGS. 2 and 3 in that a pipe joint restraint 100 is provided which has a gland 102 connected to a flanged end 104 of a second pipe portion 106 (or other structure) which can assist in connecting to a first pipe portion 108, not only to provide a water-tight connection with a gasket 110 as has been known in prior art, but possibly also utilizing the wire structure or grip 112 which might at least partially be retained in position with the gland 102 or not, while possibly also simultaneously assisting in deforming the gasket 110 to provide a water-right seal. Once again, bolts 114 and/or nuts 116 may be useful to provide the desired compressive nature of the gland 102 particularly with its foot 118 possibly against at least one of the gasket 110 and/or the wire structure 112.

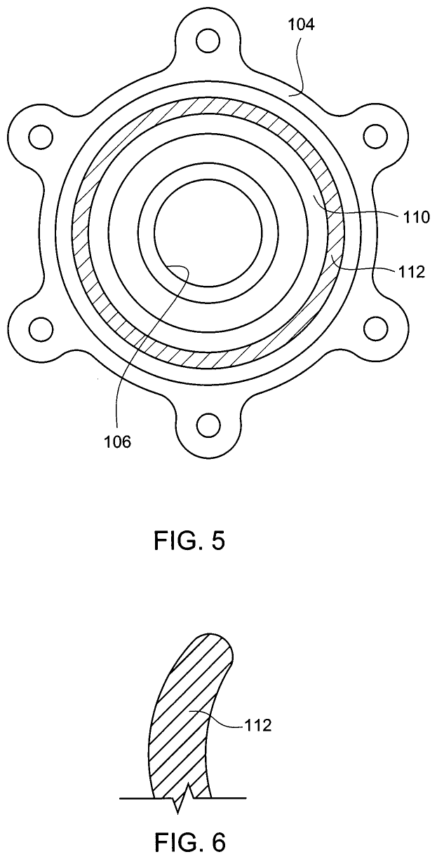

Flanged end 104 shown in FIG. 5 which also could be flanged end 14 (FIG. 2) or end of second pipe portion 54 (FIG. 3) is shown looking at the wire structure or grip 112 and the gasket 110 before inserting and end 121 of the first pipe portion 120 into the second pipe portion 106. The first pipe portion can terminate at the end 121 and may have a beveled leading edge 123 for at least some embodiments.

FIG. 6 shows a detailed view of the wire structure or grip 112. Grip 112 could be at least one of a wire rope, a braided wire, a twisted wire, a cable and/or other preferably potentially deformable and at least partially ring like structure to at least substantially circumnavigate the exterior circumference of the first pipe portion 120, such as at least ⅔ of the circumference, at least ¾ of the circumference, or even about all of the circumference.

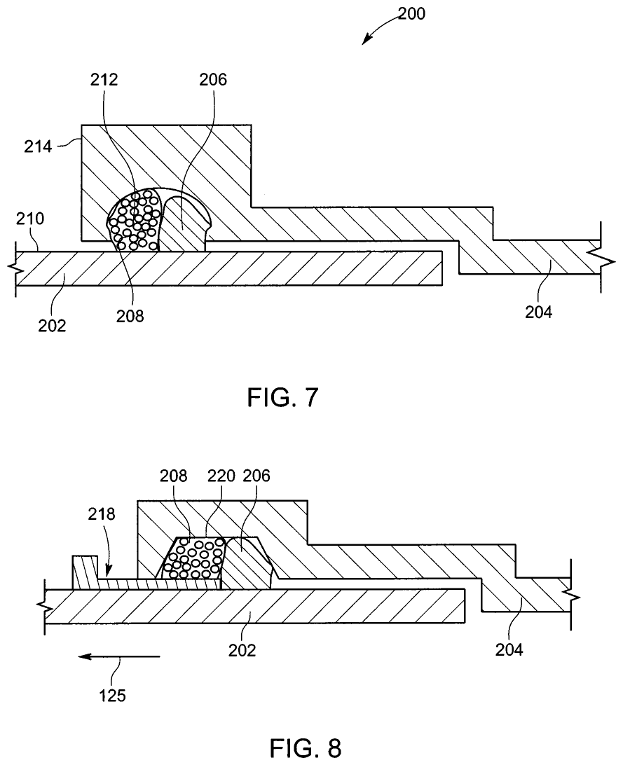

It is not necessary for all embodiments for the wire structure 112 to completely circumnavigate the exterior surface 122 of the first pipe portion 120 but can for many embodiments. FIG. 7 shows what may be a galvanized pipe connection having a pipe joint restraint 200 with a first pipe portion 202 connected to a second pipe portion 204 which may have a gasket 206 to provide a water-right seal, while also provide a wire structure or grip 208 which may preferentially be directed against the exterior surface 210 by a rearward facing ramp 212 pointing from a first end 214 towards a length of the second pipe portion 204 or in the direction 216 (relative to pipe portion 204) illustrated in FIG. 7 which could be internal to or along the second pipe portion 204 as opposed to directed away therefrom. The ramp 212 can assist in deforming the wire structure or grip 208 against the exterior surface 210 to provide a pipe restraining under at least some situations such as through compression. In order to separate the first pipe portion 202 from the second pipe portion 204, it may be that a slide 218 such as shown in FIG. 8 may be inserted between the first and second pipe portions 202,204 so as to push the wire structure or grip 208 at least more into cavity 220 so that the first pipe portion 202 may be twisted relative to the second pipe portion 204 and/or pulled straight out as illustrated. Twisting alone may be sufficient for other embodiments.

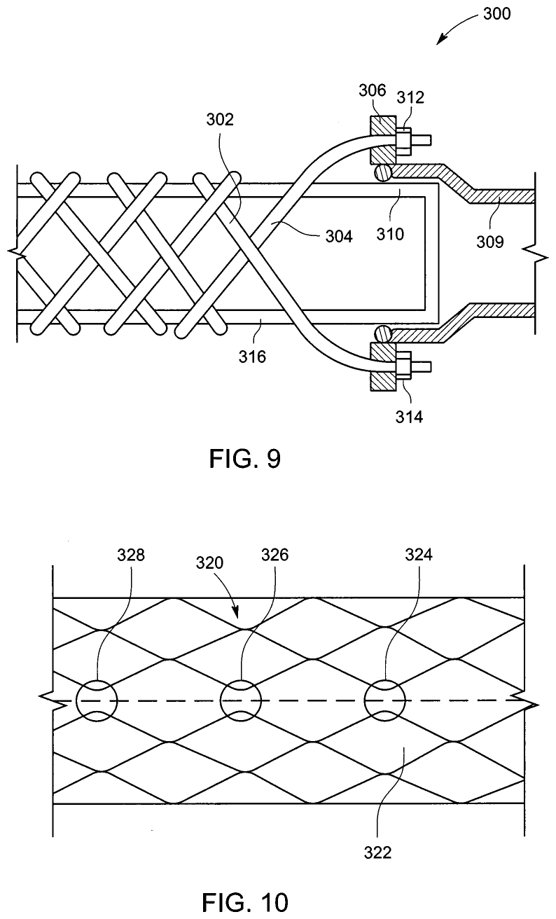

FIG. 9 can operate differently from the embodiments of FIG. 2-8 in the fact that it shows a pipe connection 300 having a plurality of wire strands 302,304 etc., which can connect either to a gland 12 which can be bolted to a flanged end 14 such as in FIG. 2 or the wires could be directed through flanged end 306 of second pipe portion 308 so as to connect first pipe portion 310 possibly with the wires 302,304 etc. having threaded exterior surfaces as they pass through and beyond the flange 306 to be connected to nuts 312,314 etc. so that as the wires 302,304 etc. are pulled, a tension force may be applied through the wires 302,304 or grip compress against an exterior surface 316 of the first pipe portion 310 so as to provide a pipe joint restraint 300 as would be understood by those of ordinary skill in the art. This construction is different from U.S. Pat. No. 1,670,543 as the wires 302,304, etc. are pulled separately by nuts 312,314 (potentially to provide for separate tensioning) as opposed to a single nut pulling all the wires simultaneously. In fact, wires 312,314 are pulled from locations external to the first pipe portion 316.

For some embodiments, it may be that the wires 302,304 provided in the form of a grip which is preconstructed prior to installing about the exterior surface 316. In other embodiments it may be possible that there is a seam so that there can be first half 320 which can be connected to a second half 322 such as may be along the rear side of the obscured view of FIG. 9 but shown in FIG. 10, which could be connected by one or more connectors 324,326,318 etc., after the halves 320,322 are placed about the exterior of the surface 316 of the first pipe portion 310. While rings are shown as connectors 324,326,328 wire and/or other structure could be utilized for other embodiments to connect halves 320,322.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed herein is:

1. A pipe restraint comprising:
a first pipe portion terminating at a first end extending along away from a pipe direction;
an exterior wire based grip extending circumferentially about an exterior surface portion; and
a connection member selected from one of a second pipe portion and a flanged end, said connection member receiving the first end of the first pipe portion internally thereto, said connection member contacting the grip internal to the connection member in one of tension and compression thereby at least assisting in depressing the grip against the exterior surface portion of the first pipe portion to assist in restraining the first pipe portion from outward movement away from the connection member in the pipe direction.

2. The pipe restraint of claim 1 wherein the wire based grip is a wire based ring.

3. The pipe restraint of claim 2 wherein the wire based ring encircles the exterior surface of the first pipe portion.

4. The pipe restraint of claim 1 wherein the wire based grip encircles and contacts at least ⅔ of a perimeter about an exterior surface of the first pipe portion.

5. The pipe restraint of claim 4 wherein the wire based grip is a continuous circle.

6. The pipe restraint of claim 1 wherein the wire based grip is comprised of one of wire rope, braided wire and twisted wire.

7. The pipe restraint of claim 1 further comprising a gasket located between the exterior surface portion of the first pipe portion and the connection member providing a water tight seal.

8. The pipe restraint of claim 7 wherein the wire based grip is connected to the gasket.

9. The pipe restraint of claim 7, wherein the wire based grip is adjacently disposed beside the gasket.

10. The pipe restraint of claim 1 wherein the connection member has one of a groove and a ramp, said grip located against the one of a surface of the groove and the ramp which applies a downward force against the grip in to the exterior surface of the first pipe portion.

11. The pipe restraint of claim 10 further comprising a gland about the exterior surface of the first pipe portion, said gland connected by bolts to the flanged end of the connection member.

12. The pipe restraint of claim 11 wherein the gland has an upwardly sloped ramp contacting the wire based grip, said ramp applying a downward force through the wire based grip into the exterior surface

13. The pipe restraint of claim 10 further comprising a gasket located in the groove, and the wire based grip is adjacently disposed relative to the gasket.

14. The pipe restraint of claim 1 further comprising a gland about the first pipe portion said gland connected by bolts to the flanged end of the connection member.

15. The pipe restraint of claim 14 wherein the gland has an upwardly sloped ramp contacting the wire based grip, said ramp applying a downward force through the wire based grip into the exterior surface.

16. The pipe restraint of claim 1 wherein the connection member is the flanged end and the exterior wire based grip is comprised of a plurality of wires extending in a grid about the exterior surface of the first pipe portion and connected to the flanged end of connection member externally disposed to the first pipe portion.

17. The pipe restraint of claim 16 wherein the flanged end of the pipe portion has a plurality of bores respectively receiving the plurality of wire there through.

18. The pipe restraint of claim 17 wherein the wires are respectively pulled under tension by nuts through the bores.

19. The pipe restraint of claim 16 wherein the wire based grip is formed as a first and second half spaced by initially by a gap which is then placed about the first pipe portion and secured with at least one connector.

20. The pipe restraint of claim 1 further comprising a gasket and the grip is located gasket is located closer to the end of the first pipe portion than the grip.
